(19) United States
(12) Patent Application Publication
(10) Pub. No.: US 2025/0384894 A1
(43) Pub. Date: Dec. 18, 2025

(54) NATURAL LANGUAGE PROCESSING TO IDENTIFY MISMATCHED AIRCRAFT CONFIGURATIONS ON AN INTEGRATED AVIONICS SYSTEM

(71) Applicant: Rockwell Collins, Inc., Cedar Rapids, IA (US)

(72) Inventors: Sumit Shibib, Beaverton, OR (US); Fahmid Shibib, Cedar Rapids, IA (US)

(21) Appl. No.: 18/742,843

(22) Filed: Jun. 13, 2024

(51) Int. Cl. G10L 25/51; G10L 15/14; G10L 15/26

(52) U.S. Cl. CPC G10L 25/51; G10L 15/14; G10L 15/26

(57) ABSTRACT

A system may obtain input data from the pilot input device. A system may process the input data into text. A system may obtain a trained artificial intelligence (AI) and/or machine learning (ML) checklist model. A system may analyze the text via the trained AI and/or ML checklist model, wherein analyzing the text via the trained AI and/or ML checklist model comprises: determining if the text describes a checklist item; and if the text describes the checklist item, determining if the text further describes an intended aircraft configuration based on the checklist item. A system may compare the intended aircraft configuration to a current aircraft configuration. A system may if a mismatch between the intended aircraft configuration and the current aircraft configuration is detected, send an alert signal to the output device.

### BACKGROUND

Checklists are tools used by flight crews that support airmanship and ensure that all required actions are performed without omission and in an orderly manner. For flight crews that include two or more pilots, one pilot may read off one or more checklist items from an electronic or paper checklist, while another pilot will check whether the checklist item has been carried out and/or set correctly. While checklists reduce errors during the phases of flight, it is possible that a checklist item may be read correctly by one pilot, but applied incorrectly by the other pilot. A misapplied checklist item could result in a catastrophic incident, especially during takeoff and landing phases. Current aircraft systems lack an ability for identifying if checklist item has been misapplied. Therefore, there is a need for a system and method to identify a checklist item communicated by the pilot, and determine if the checklist item communicated by the pilot has been misapplied.

### SUMMARY

In some aspects, the techniques described herein relate to a system including: a speech recognition comparison system (SRCS) communicatively coupled to a pilot input device and an output device, the SRCS including at least one processor configured to: obtain input data from the pilot input device; process the input data into text; obtain a trained artificial intelligence (AI) and/or machine learning (ML) checklist model; analyze the text via the trained AI and/or ML checklist model, wherein analyzing the text via the trained AI and/or ML checklist model includes: determining if the text describes a checklist item; and if the text describes the checklist item, determining if the text further describes an intended aircraft configuration based on the checklist item; compare the intended aircraft configuration to a current aircraft configuration; and if a mismatch between the intended aircraft configuration and the current aircraft configuration is detected, send an alert signal to the output device.

In some aspects, the techniques described herein relate to a system, wherein the pilot input device includes a microphone.

In some aspects, the techniques described herein relate to a system, wherein the pilot input device includes a remote interface unit.

In some aspects, the techniques described herein relate to a system, wherein the input data is processed into text via natural language processing (NLP).

In some aspects, the techniques described herein relate to a system, wherein the trained AI and/or ML checklist model includes a large language model (LLM).

In some aspects, the techniques described herein relate to a system, wherein the LLM is implemented via a probabilistic model or a neural network model.

In some aspects, the techniques described herein relate to a system, wherein the LLM is implemented via a neural network model.

In some aspects, the techniques described herein relate to a system, wherein the neural network model includes a recurrent neural network including one or more network layers.

In some aspects, the techniques described herein relate to a system, wherein the recurrent neural network includes a long-short term memory (LSTM) block including a plurality of memory cells.

In some aspects, the techniques described herein relate to a system, wherein the LSTM block includes: an input gate configured to capture an input value from the text and update a memory cell with the input value; a forget gate configured to determine one or more values to discard from the LSTM block; and an output gate configured to control a transfer of one or more values of the LSTM block to a next network layer of the recurrent neural network.

In some aspects, the techniques described herein relate to a system, wherein the at least one processor is further configured to: analyze a duplicate text, or another text based on duplicate input data, via the trained AI and/or ML checklist model; determine a duplicate intended aircraft configuration based on the duplicate text or the another text based on the duplicate input data; compare the intended aircraft configuration to the duplicate intended aircraft configuration; and if a mismatch between the intended aircraft configuration and the duplicate intended aircraft is detected, decline to send the alert signal to the output device.

In some aspects, the techniques described herein relate to a system, wherein the output device includes at least one of a head-up display (HUD), a speaker, an engine indicating and crew alerting system (EICAS), an onboard maintenance system (OMS), a flight data recorder (FDR), or a helmet mounted display (HMD).

In some aspects, the techniques described herein relate to a system, wherein the output device includes an HUD.

In some aspects, the techniques described herein relate to a system, wherein the output device includes an HMD.

In some aspects, the techniques described herein relate to a system, further including the pilot input device.

In some aspects, the techniques described herein relate to a system, further including the output device.

In some aspects, the techniques described herein relate to a system including: a pilot input device; an output device; and a speech recognition comparison system (SRCS) communicatively coupled to the pilot input device and the output device, the SRCS including at least one processor configured to: obtain input data from the pilot input device; process the input data into text; obtain a trained artificial intelligence (AI) and/or machine learning (ML) checklist model; analyze the text via the trained AI and/or ML checklist model, wherein analyzing the text via the trained AI and/or ML checklist model includes: determining if the text describes a checklist item; and if the text describes the checklist item, determine if the text further describes an intended aircraft configuration based on the checklist item; compare the intended aircraft configuration to a current aircraft configuration; and if a mismatch between the intended aircraft configuration and the current aircraft configuration is detected, send an alert message to the output device.

In some aspects, the techniques described herein relate to a system, wherein the input data is processed into text via natural language processing, wherein the trained AI and/or ML checklist model includes a large language model (LLM), wherein the LLM is implemented via a neural network model, wherein the neural network model includes a recurrent neural network, wherein the recurrent neural network includes a long-short term memory (LSTM) block.

In some aspects, the techniques described herein relate to a method for identifying mismatched aircraft configurations including obtaining input data from a pilot input device; processing the input data into text; obtaining a trained artificial intelligence (AI) and/or machine learning (ML) checklist model; analyzing the text via the trained AI and/or ML checklist model, wherein analyzing the text via the trained AI and/or ML checklist model includes: determining if the text describes a checklist item; and if the text describes the checklist item, determining if the text further describes an intended aircraft configuration value based on the checklist item; comparing the intended aircraft configuration value to a current aircraft configuration value; and if a mismatch between the intended aircraft configuration value and the current aircraft configuration value is detected, sending an alert message to an output device.

In some aspects, the techniques described herein relate to a method, further including: analyzing a duplicate text, or another text based on duplicate input data, via the trained AI and/or ML checklist model; determining a duplicate intended aircraft configuration value based on the duplicate text or the another text based on the duplicate input data; comparing the intended aircraft configuration value to the duplicate intended aircraft configuration value; and if a mismatch between the intended aircraft configuration value and the duplicate intended aircraft value is detected, declining to send the alert message.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1 illustrates a block diagram illustrating a system for identifying mismatched aircraft configurations, in accordance with one or more embodiments of this disclosure.

FIG. 2 illustrates a block diagram illustrating a system for identifying mismatched aircraft configurations, in accordance with one or more embodiments of this disclosure.

FIG. 3 illustrates a process flow diagram depicting a method for identifying mismatched aircraft configurations, in accordance with one or more embodiments of the disclosure.

FIG. 4 illustrates an avionics environment using a system for identifying mismatched aircraft configurations, in accordance with one or more embodiments of the disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein may be directed to a method and system including a speech recognition comparison system (SRCS) configured to use an artificial intelligence (AI) and/or machine learning (ML) checklist model to determine if there is a mismatch between a communicated intended aircraft configuration value (e.g., spoken by a pilot reading a checklist), and a current aircraft configuration value. If the intended aircraft configuration value does not match the current aircraft configuration value (e.g., after a time period that the aircraft configuration should have been implemented after the intended aircraft configuration value was communicated) the SRCS outputs an alert message or signal that alerts the pilot or other personnel.

In embodiments, the SRCS is able to obtain input data from spoken checklist phrases and convert them to text via natural language processing (NLP). The text is then used for analysis by the AI/ML checklist model to determine both the checklist item that has been called out and the intended aircraft configuration value of the called-out checklist item.

In embodiments, the SRCS may be implemented with current aircraft safety systems such as an engine indicating and crew alerting system (EICAS), an onboard maintenance system (OMS). Alert messages may be sent directly to the pilot via a helmet-mounted display (HMD), a head-up display (HUD), or by other means.

Currently, there is no automated system or method for identifying checklist items and aircraft configuration values associated with checklist items communicated by the pilot, determining mismatches between the checklist items and/or aircraft configuration values and the checklist items communicated by the pilot in real time, storing the mismatch information for further analysis (e.g., for post flight analysis), and determining if the checklist items have been properly executed. The system and method of the current disclosure therefore automatically assesses the checklist communications to see if they have been properly checked and followed, potentially reducing accidents and other mishaps due to improper aircraft configurations that were generated based on misapplied checklist values.

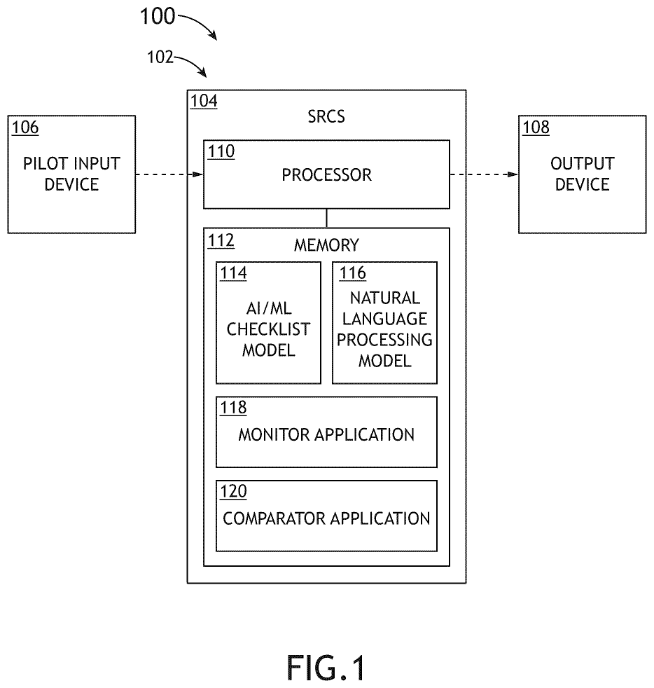

Referring now to FIGS. 1-4, exemplary embodiments of a system 100 according to the inventive concepts disclosed herein are depicted. In some embodiments, the system 100 may include an aircraft 102. The system 100 may include at least one SRCS 104, at least one pilot input device 106 configured to send an audio input (e.g., a spoken checklist item and/or aircraft configuration value to the SRCS), and an output device configured to receive an SRCS output.

The SRCS 104 may be implemented as any suitable computing device. The SRCS 104 may include any or all of the elements, as shown in FIG. 1, in accordance with one or more embodiments of the disclosure. For example, the SRCS 104 may include at least one processor 110, at least one memory 112 (e.g., which may maintain a trained artificial intelligence (AI) and/or machine learning (ML) checklist model 114, and a natural language processing model 116), and/or at least one storage, some or all of which may be communicatively coupled at any given time. For example, the at least one processor 110 may include at least one central processing unit (CPU), at least one graphics processing unit (GPU), at least one field-programmable gate array (FPGA), at least one application-specific integrated circuit (ASIC), at least one digital signal processor, at least one deep learning processor unit (DPU), at least one virtual machine (VM) running on at least one processor, and/or the like configured to perform (e.g., collectively perform) any of the operations disclosed throughout. For example, the at least one processor 110 may include a CPU and a GPU configured to perform (e.g., collectively perform) any of the operations disclosed throughout. The processor 110 may be configured to run various software applications or computer code stored (e.g., maintained) in a non-transitory computer-readable medium (e.g., memory 112 and/or storage) and configured to execute various instructions or operations. The memory 112 may also store and maintain monitor applications 118 and comparator applications 120 that can receive the intended aircraft configuration value, determine a current aircraft configuration value, and determine whether the intended aircraft configuration value matches the current aircraft configuration value.

In another example, the at least one processor 110 of the SRCS 104 may be configured to: obtain input data from the pilot input device 106, process the input data into text, obtain a trained artificial intelligence (AI) and/or machine learning (ML) checklist model, analyze the text via the trained AI and/or ML checklist model, wherein analyzing the text via the trained AI and/or ML checklist model comprises determining if the text describes a checklist item and, if the text describes the checklist item, determining if the text further describes an intended aircraft configuration value based on the checklist item, and compare the intended aircraft configuration value to a current aircraft configuration.

In embodiments, if a mismatch between the intended aircraft configuration value and the current aircraft configuration value is detected, the at least one processor 110 is configured to send an alert message to the output device 108.

In embodiments, the system 100 is configured to process the output from the pilot (e.g., a spoken checklist item and/or aircraft configuration value) in multiplicate (e.g., duplicate, triplicate, or more). By processing the output from the pilot more than once, the multiple outputs of the SRCS 104 can be compared to each other to ensure that the output from the SRCS is consistent. In embodiments, the at least one processor is configured to at least one of analyze an input from the pilot more than once to produce a duplicate text, analyze the duplicate text, or another text based on duplicate input data, via the trained AI and/or ML checklist model, determine a duplicate intended aircraft configuration value based on the duplicate text or another text based on the duplicate input data, compare the intended aircraft configuration to the duplicate intended aircraft configuration, and if a mismatch between the intended aircraft configuration value and the duplicate intended aircraft is detected, decline to send the alert message to the output device. The multiplicate processing by the system may be performed sequentially by the one set of system components of the system 100 (e.g., one SRCS 104), or may be performed by duplicated system components of the system 100 (e.g., two or more SRCSs 104). In embodiments, upon a mismatch between multiple outputs of the system 100 based on the same input data, the SRCS 104 transmits a message to one or more output devices 108 (e.g., the EICAS) that the SRCS 104 is not active for the respective checklist conversation.

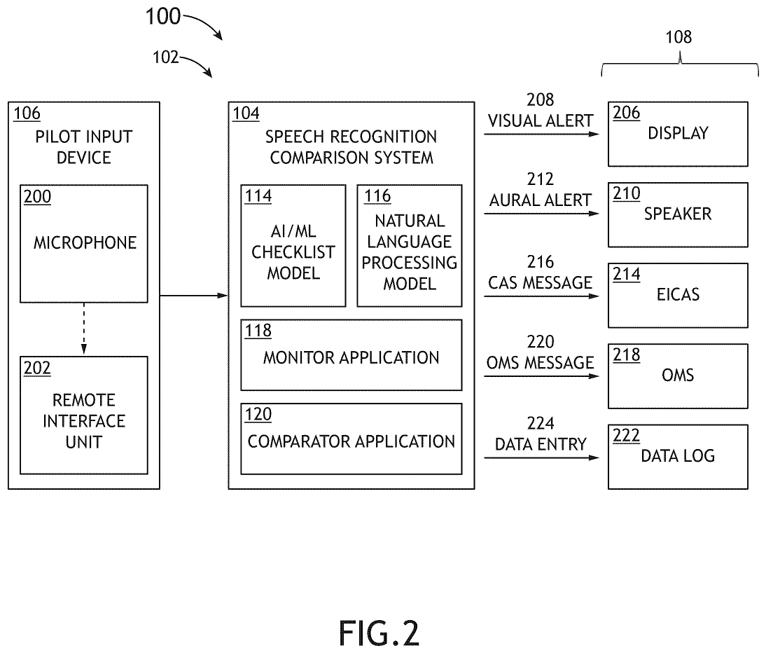

FIG. 2, illustrates a block diagram illustrating the system 100 for identifying mismatched aircraft configurations, in accordance with one or more embodiments of this disclosure. In embodiments, the pilot input device 106 may include one or more microphones 200 configured to receive audio input (e.g., spoken words) from a pilot, copilot, crew member, or other aircraft personnel. In embodiments, the pilot input device104 may include a remote interface unit 202. The remote interface unit 202 routes one or more audio feeds (e.g., from the pilot intercom) to the SRCS 104 and may convert/adjust the incoming signal. For example, the remote interface unit 204 may convert an analog audio input to a digital audio input.

In embodiments, the output device 108 may include one or more displays 206 configured to display a visual alert 208 received from the SRCS 104 and/or one or more speakers 210 configured to transmit an aural alert 212 received from the SRCS 104. For example, the one or more speakers 210 may transmit an aural alert 212 received from the SRCS 104 via the remote interface unit 202.

In embodiments, the output device 108 may include an Engine Indicating and Crew Alerting System (EICAS) or other alerting system configured to display a crew alerting system alert message (CAS message 216) received from the SRCS 104, an onboard maintenance system (OMS 218), configured to display an onboard maintenance system alert message (OMS message 220) received from the SRCS 104, and/or a data log 222 configured to receive a record of an alert as a data entry 224. For example, the data log may include a recording device integrated within a flight data recorder (FDR), a hydro-mechanical unit (HMU), or an Onboard Maintenance Software Application (OMSA).

In embodiments, the one or more displays 206 may include, but not be limited to, one or more primary flight displays (PFD), one or more head-up displays (HUD), one or more head-worn displays (HWD), one or more helmet mounted displays (HMD), one or more multi-function displays (MFD), one or more navigation displays (ND), one or more EICAS displays, one or more electronic flight instrument system (EIFS) displays, a weather radar display, a traffic collision avoidance system (TCAS) display, or a flight management system (FMS) display.

In embodiments, the input data from the pilot input device 106 is processed into text through NLP via the natural language processing model 116. For example, the natural language processing model 116 may include algorithms configured to generate human language text from an audio input. The natural language processing model 116 may include one or more NLP processes including, but not limited to, parsing, semantic analysis, sentiment analysis, speech recognition, natural language generation, machine translation, named, entity recognition, and/or text classification and categorization. For example, the natural language processing model 116 may be configured to receive audio data from a remote interface unit 202 based on spoken words, recognize at least a portion of the audio data as speech data, and transform the speech data into written text. The natural language processing model 116 may include one or more portions of, or be similar to, known NLP models including, but not limited to, BERT, XLNet, ROBERTa, ALBERT, PaLM, and GPT-3. Once the audio input has been transformed into text, the text is then utilized by the trained AI and/or ML checklist model 114 for further processing.

In embodiments, the trained AI and/or ML checklist model 114 may be trained via one or more learning techniques including, but not limited to, unsupervised learning, supervised learning, self-supervised learning, and reinforced learning. For example, the trained AI and/or ML checklist model 114 may include a large language model (LLM) trained via reinforced learning, supervised learning, and self-supervised learning. The trained AI and/or ML checklist model 114 may include aspects from other models including but not limited to transformer models (e.g., BERT, GPT, and T5) and sequence-to-sequence models (e.g., long-short term memory (LSTM) models).

In embodiments, the trained AI and/or ML checklist model 114 may include an LMM model that is implemented via a probabilistic model (e.g., a Hidden Markov Model (HMM) or n-gram model) or a neural network model (e.g., a recurrent neural network (RNN) model, a convolutional neural networks (CNN) model, or a deep belief networks (DBN) model). For example, the LLM model may be implemented as a multi-layered RNN model that includes an LSTM network.

LSTM networks are capable of remembering context. For example, LSTM networks can remember important information from the beginning of a text and recall the information at a considerably later point in time. This ability for long-term memory is useful in scenarios where a pilot asks the co-pilot to set a certain system to a certain value, and the co-pilot only reiterates the value they have the set system to instead of mentioning the name of the system again.

Long Short-Term Memory (LSTM) networks are designed to process sequences of data, like speech or text, and may avoid a “vanishing gradient problem” that occurs when a recurrent neural network loses track of information if a data sequence becomes too lengthy. The LSTM network includes blocks containing cells that are used to store information.

LSTMs manage information using structures referred to as ‘gates’. The major gates in an LSTM network include an input gate that devices which captures values from the input (e.g., text) to update a memory state, a forget gate that determines what information to discard from the LSTM block, and an output gate configured to transfer information from the LSTM block to a next layer of the network. By selectively updating and forgetting information, LSTMs can maintain a long-term memory and are effective for tracking spoken checklist items and intended aircraft configurations.

As used herein, “aircraft configurations” include one or more values for a checklist item that are set for a flight phase. For example, for a checklist item, “Autopilot”, the aircraft configuration may be “ON” or “OFF” (e.g., “ON” and “OFF each constituting an aircraft configuration value). In another example, for a checklist item “Spoilers”, the checklist item may be “ARMED” or “UNARMED”. As used herein, an intended aircraft configuration value includes the aircraft configuration value that is intended for the phase of flight, as indicated by the pilot and/or copilot. For example, for a landing checklist, where the autopilot is intended to be activated during the landing phase, the value of the intended aircraft configuration value is “ON”. In another example, for the landing checklist, where the spoiler is intended to be armed during the landing phase, the value of the intended aircraft configuration value is “ARMED”. Table 1 includes portions of a voice transcription between a pilot annunciating checklist items and a copilot repeating the checklist item (e.g., a checklist query) and annunciating a respective aircraft configuration value (e.g., a checklist response) associated with the checklist item for the phase of flight. The table further includes an intended checklist item and an intended aircraft configuration value corresponding to the respective annunciated checklist item and annunciated aircraft configuration value.

TABLE 1

| | | Intended Checklist | Intended Aircraft |
|---|---|---|---|
| Checklist Query | Checklist Response | Item | Configuration Value |
| All right, time for final | Okay, final approach | | |
| approach. Let's start | checklist | | |
| the checklist | | | |
| Autopilot - as required | Autopilot is on | Autopilot | On |
| Spoilers armed | Armed | Spoilers | Armed |
| Flaps set for landing | Flaps set to 30 | Flaps | Set to 30 |
| Trim for landing | Trimmed for landing | Trim | Trimmed for Landing |
| Gear down | Gear down | Gear | Down |
| Confirm approach | Approach ILS 27R. | Approach | ILS 27R |
| | ILS CRS set to 270 | ILS Course | 270 |

In embodiments, the SRCS 104 is configured to convert the recorded speech of the checklist conversation, such as the checklist query and checklist response in Table 1) into text. The SRCS 104 may then extract the intended checklist item and the intended aircraft configuration value from the text. For example, the system 100 may convert the recorded speech to text and enter intended checklist items and intended aircraft configuration values extracted from the text into a table.

In embodiments, the SRCS 104 is configured to refer to a database (e.g., a reference table or lookup table) that includes a list of values and labels that correspond to the checklist item, along with a list of possible aircraft configuration values for the checklist item, one of which may match the intended aircraft configuration value. For example, the SRCS may use the database to look up aircraft configuration values, which include labels, label names, bits, bit-values, and other values that correspond to the checklist items as identified based on the text generated from the recorded speech. An example reference table that includes these values and labels is shown in TABLE 2. One or more checklist items may include more than one configuration value. For example, the checklist item “trim” has three possible aircraft configuration values “Landing”, “Cruise”, and “Takeoff” as shown in TABLE 2.

TABLE 2

| | Aircraft | | | | Bit |
|---|---|---|---|---|---|
| Checklist Item | Configuration Value | Label | Label Name | Bit | Value |
| Autopilot | ON | 270 | FCA_AP_Status | 20 | 1 |
| Autopilot | OFF | 270 | FCA_AP_Status | 20 | 0 |
| Spoilers | ARM | 260 | Spoiler Status | 10 | 1 |
| Spoilers | OFF | 260 | Spoiler Status | 10 | 0 |
| Flaps | 10 | 151 | Flap_Angle | 30 | 10 |
| Flaps | 20 | 151 | Flap_Angle | 30 | 20 |
| Flaps | 30 | 151 | Flap_Angle | 30 | 30 |
| Trim | Landing | 300 | Pitch_Trim | 7 | 3-5 deg |
| Trim | Cruise | 300 | Pitch_Trim | 7 | 1-3 deg |
| Trim | Takeoff | 300 | Pitch_Trim | 7 | 3-5 deg |
| Gear | Down | 231 | Gear_status | 23 | 1 |
| Gear | Up | 231 | Gear_status | 23 | 0 |
| Approach Runway | <Variable> | 240 | FMS_Appr Rwy | <N/A> | <Variable> |
| ILS CRS | <Variable> | 240 | FMS A ppr_CRS | <N/A> | <Variable> |

In embodiments, the SRCS 104 generates via the AI/ML checklist model a database (e.g., a table) containing checklist items and respective intended aircraft configuration values along with values of one or more parameters (labels, label names, bit, and bit values) associated with the checklist items and respective intended aircraft configuration values. The generated database organizes the parameters in a standardized format (e.g., specific to the avionics system and/or aircraft), allowing them to be compared to a set of data that includes current aircraft configuration parameters. An example table that includes the checklist items, respective intended aircraft configuration values, and values of parameters associated with the checklist items and respective intended aircraft configuration values is shown in Table 3.

TABLE 3

| Checklist | Intended Aircraft | | | | Bit |
|---|---|---|---|---|---|
| Item | Configuration Values | Label | Label Name | Bit | Value |
| Autopilot | On | 270 | FCA_AP_Status | 20 | 1 |
| Spoilers | Armed | 260 | Spoiler_Status | 10 | 1 |
| Flaps | Set to 30 | 151 | Flap_Angle | 30 | 30 |
| Trim | Trimmed for landing | 300 | Pitch_Trim | 7 | 3-5 deg |
| Gear | Down | 231 | Gear_status | 23 | 1 |
| Approach | ILS27R | 240 | FMS_Appr_Rwy | N/A | ILS27R |
| ILS Course | 270 | 240 | FMS_Appr_CRS | N/A | 270 |

In embodiments, the values for the bits, bit values, and labels for the intended aircraft configuration values are compared with current (e.g., real) aircraft configuration values via the monitor application 118 and comparator application 120. For example, the SRCS 104 may receive current aircraft configuration values from one or more aircraft systems and/or aircraft components. For instance, the SRCS 104 may receive a status of the autopilot from an autopilot control system or flight deck control onboard the aircraft (via the monitor application 118 and/or comparator application 120). In another example, the SRCS 104 may receive a status of the spoiler from the flight deck control. Once the status information is received, the comparator function of the software compares the intended aircraft configuration value of the checklist item to the current aircraft configuration. If the intended aircraft configuration value of the checklist item and the current aircraft configuration value of the checklist item does not match, the SRCS 104 will send an alert signal to the output device 108 (e.g., to the EICAS). If the intended aircraft configuration value of a checklist item and the current configuration aircraft configuration value of the checklist item do not match, the SRCS may either send a match signal to the output device 108, or decline to send a message to the output device.

In embodiments, the SRCS 104 performs an attempt to identify a mismatched aircraft configuration (e.g., mismatched between the intended aircraft configuration value of a checklist item and the current configuration aircraft configuration value of the checklist item) after a time interval. For example, the SRCS may wait for a period of time for the aircraft to carry out a change in the aircraft configuration value (e.g., an adjustment of the spoiler) before attempting to identify if the intended and current aircraft configurations are mismatched. In another example, if the initial attempt to identify a mismatched aircraft configuration is positive, the SRCS 104 may monitor the system and/or component after a time interval and retry the mismatch comparison to ensure that the positive mismatch was not due to the SRCS 104 making a comparison before the checklist item could change status.

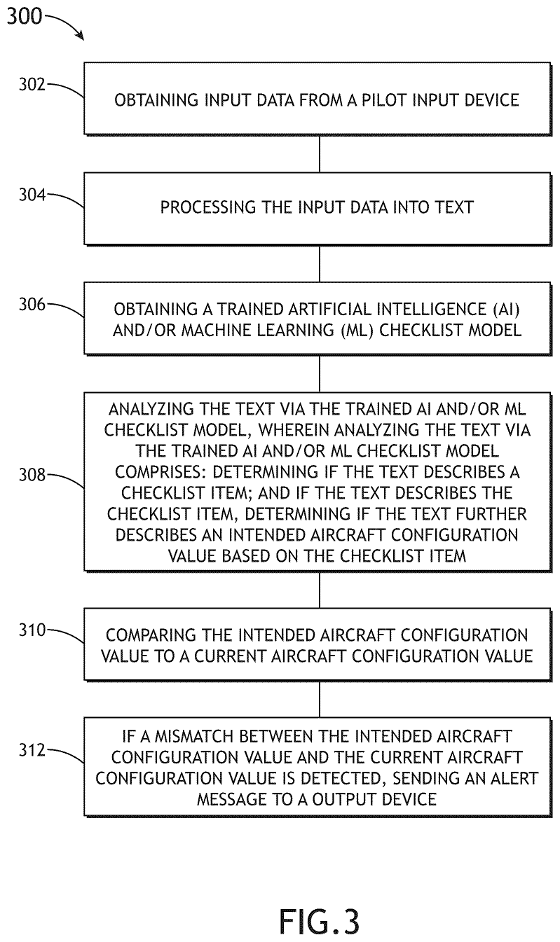

FIG. 3 illustrates a process flow diagram depicting a method 300 for identifying mismatched aircraft configurations, in accordance with one or more embodiments of the disclosure. For example, the method 300 may detect an aircraft configuration mismatch that would occur if the pilot announced a checklist item, and the copilot replied with an announced aircraft configuration value (e.g., an intended aircraft configuration value), but accidentally configured the associated aircraft component or system to a wrong aircraft configuration value (e.g., a current aircraft configuration value). For instance, in a landing phase, where the pilot states “Gear down”, the copilot responds “Gear down”, but the landing gear remains up due to either an error on the copilot or a mechanical malfunction of the landing gear mechanism, the method 300 will send an alert signal to the output device 108 informing the pilot and copilot that the current aircraft configuration value is different than the intended configuration value.

In embodiments, the method 300 includes a step 302 of obtaining input data from a pilot input device 106. For example, the remote interface unit 202 may receive voice data from the pilot intercom and relay the voice data as input data to the SRCS 104.

In embodiments, the method 300 includes a step 304 of processing the input data into text (e.g., textual data). For example, the SRCS may process the input data through NLP methods via the natural language processing model 116 into text that can be further analyzed by the AI/ML Checklist model 114.

In embodiments, the method 300 includes a step 306 of obtaining a trained AI/ML checklist model 114. For example, the AI/ML checklist model 114 may include a large language model (LLM). For instance, the AI/ML checklist model 114 may include a neural network model, such as a recurrent neural network model comprising one or more network layers. In particular, the AI/ML checklist model 114 may include an LLM model that includes a recurrent neural network model that includes long-short term memory (LSTM) blocks.

In embodiments, the method 300 includes a step 308 of analyzing the text via the trained AI and/or ML checklist model 114. For example, the text may be analyzed to determine if the text described a checklist item (e.g., such as “GEAR”). In another example, if the text describes the checklist item, the text will be further analyzed to determine if the text further describes an intended aircraft configuration based on the checklist item. For example, if the checklist item “GEAR” is identified in the text, the text is further analyzed to determine if one or more aircraft configurations (e.g., “UP” or “Down”) are also associated with the text.

In embodiments, the method 300 includes a step 310 of comparing the intended aircraft configuration value to a current aircraft configuration value. For example, the monitor application 118 may monitor systems and components of the aircraft 102 and obtain current aircraft configuration values for those systems and components. The comparator application 120 may then compare the intended aircraft configuration values to the current aircraft configuration values, and determine if there is a mismatch between the two values.

In embodiments, the method 300 includes a step 312 of, if a mismatch between the intended aircraft configuration and the current aircraft configuration is detected, send an alert signal to the output device 108. For example, upon the detection of a mismatch between the intended aircraft configuration and the current aircraft configuration, the SRCS 104 may output a signal to the EICAS 214, which then generates the applicable CAS messages 216 to be displayed on the flight deck to alert the crew. Mismatches identified via the method 300 may be stored in memory 112 for later analysis, such as analysis post-flight.

In embodiments, the method 300 may include a step of performing the analysis in multiplicate (e.g., duplicate, triplicate, quadruplicate, or more) as described herein. For example, the method 300 may include analyzing a duplicate text, or another text based on duplicate input data, via the trained AI and/or ML checklist model, determining a duplicate intended aircraft configuration value based on the duplicate text or the another text based on the duplicate input data, comparing the intended aircraft configuration value to the duplicate intended aircraft configuration value, and, if a mismatch between the intended aircraft configuration value and the duplicate intended aircraft value is detected, declining to send the alert message and/or sending a message that the SRCS 104 is not active for the analysis of the input data.

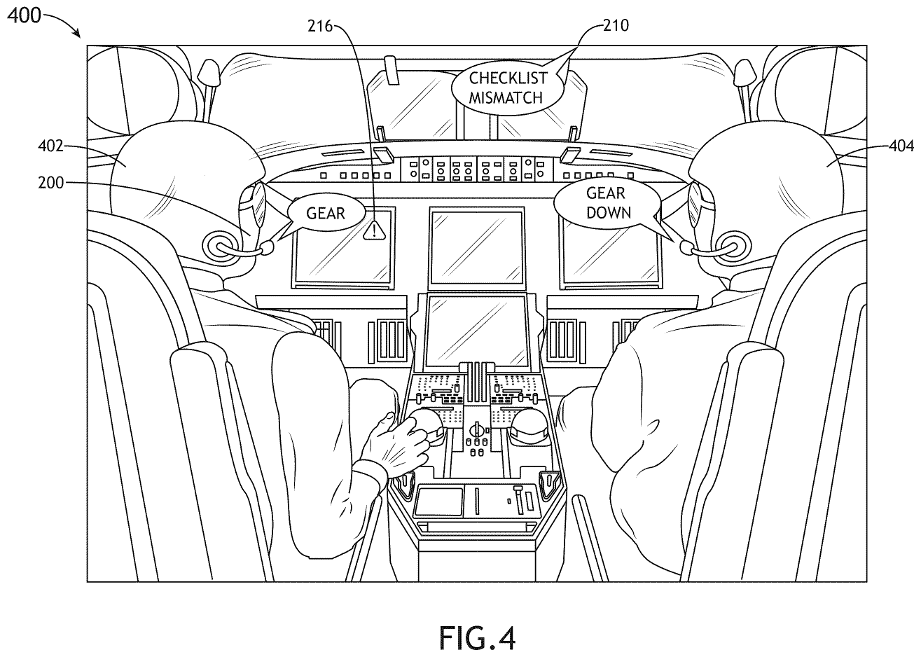

FIG. 4 illustrates an avionics environment 400 using the system 100 for identifying mismatched aircraft configurations, in accordance with one or more embodiments of the disclosure. For example, the avionics environment 400 may represent a pilot 402 and copilot 404 preparing for the landing phase of a flight In this example, the pilot 402 announces to the copilot 404 a checklist item, “gear”. The copilot 404 responds with the announcement “gear down”. Both announcements are picked up by one or more microphones 200, which transmit input data to the SRCS 104. The SRCS 104 used the natural language processing model 116 to recognize speech in the input data, transforming the input data into text. The AI/ML checklist model 114 is then used to determine the checklist item that the pilot 402 is referring to (e.g., gear), as well as the intended aircraft configuration value associated with the checklist item that the copilot was referring to (e.g., down). The AI/ML model checklist model 114 also determines at least one of the label, label name, bit, and bit value associated with the intended aircraft configuration value. The monitor application 118 obtains current aircraft configuration values associated with the intended configuration value (e.g., up), and the comparator application 120 determines if there is a mismatch between the intended aircraft configuration value and the current aircraft configuration value. If the intended aircraft configuration value (e.g., down) does not match the current configuration value (e.g., up), the system may cause a CAS message 216 to appear on a display, or may announce a warning (e.g., “CHECKLIST MISMATCH”) over the speaker 210.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

All of the methods described herein may include storing results of one or more steps of the method embodiments in a memory medium. The results may include any of the results described herein and may be stored in any manner known in the art. The memory medium may include any memory medium described herein or any other suitable memory medium known in the art. After the results have been stored, the results can be accessed in the memory medium and used by any of the method or system embodiments described herein, formatted for display to a user, used by another software module, method, or system, etc. Furthermore, the results may be stored “permanently,” “semi-permanently,” temporarily,” or for some period of time. For example, the memory medium may be random access memory (RAM), and the results may not necessarily persist indefinitely in the memory medium.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touchpad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed is:

1. A system comprising:
a speech recognition comparison system (SRCS) communicatively coupled to a pilot input device and an output device, the SRCS comprising at least one processor configured to:
obtain input data from the pilot input device;
process the input data into text;
obtain a trained artificial intelligence (AI) and/or machine learning (ML) checklist model;
analyze the text via the trained AI and/or ML checklist model, wherein analyzing the text via the trained AI and/or ML checklist model comprises:
determining if the text describes a checklist item; and
if the text describes the checklist item, determining if the text further describes an intended aircraft configuration based on the checklist item;
compare the intended aircraft configuration to a current aircraft configuration; and
if a mismatch between the intended aircraft configuration and the current aircraft configuration is detected, send an alert signal to the output device.

2. The system of claim 1, wherein the pilot input device comprises a microphone.

3. The system of claim 1, wherein the pilot input device comprises a remote interface unit.

4. The system of claim 1, wherein the input data is processed into text via natural language processing (NLP).

5. The system of claim 1, wherein the trained AI and/or ML checklist model comprises a large language model (LLM).

6. The system of claim 5, wherein the LLM is implemented via a probabilistic model or a neural network model.

7. The system of claim 5, wherein the LLM is implemented via a neural network model.

8. The system of claim 7, wherein the neural network model comprises a recurrent neural network comprising one or more network layers.

9. The system of claim 8, wherein the recurrent neural network comprises a long-short term memory (LSTM) block comprising a plurality of memory cells.

10. The system of claim 9, wherein the LSTM block comprises:
an input gate configured to capture an input value from the text and update a memory cell with the input value;
a forget gate configured to determine one or more values to discard from the LSTM block; and
an output gate configured to control a transfer of one or more values of the LSTM block to a next network layer of the recurrent neural network.

11. The system of claim 1, wherein the at least one processor is further configured to:
analyze a duplicate text, or another text based on duplicate input data, via the trained AI and/or ML checklist model;
determine a duplicate intended aircraft configuration based on the duplicate text or the another text based on the duplicate input data;
compare the intended aircraft configuration to the duplicate intended aircraft configuration; and
if a mismatch between the intended aircraft configuration and the duplicate intended aircraft is detected, decline to send the alert signal to the output device.

12. The system of claim 1, wherein the output device comprises at least one of a head-up display (HUD), a speaker, an engine indicating and crew alerting system (EICAS), an onboard maintenance system (OMS), a flight data recorder (FDR), or a helmet mounted display (HMD).

13. The system of claim 12, wherein the output device comprises an HUD.

14. The system of claim 12, wherein the output device comprises an HMD.

15. The system of claim 1, further including the pilot input device.

16. The system of claim 1, further including the output device.

17. A system comprising:
a pilot input device;
an output device; and
a speech recognition comparison system (SRCS) communicatively coupled to the pilot input device and the output device, the SRCS comprising at least one processor configured to:
obtain input data from the pilot input device;
process the input data into text;
obtain a trained artificial intelligence (AI) and/or machine learning (ML) checklist model;
analyze the text via the trained AI and/or ML checklist model, wherein analyzing the text via the trained AI and/or ML checklist model comprises:
determining if the text describes a checklist item; and
if the text describes the checklist item, determine if the text further describes an intended aircraft configuration based on the checklist item;
compare the intended aircraft configuration to a current aircraft configuration; and
if a mismatch between the intended aircraft configuration and the current aircraft configuration is detected, send an alert message to the output device.

18. The system of claim 17, wherein the input data is processed into text via natural language processing, wherein the trained AI and/or ML checklist model comprises a large language model (LLM), wherein the LLM is implemented via a neural network model, wherein the neural network model comprises a recurrent neural network, wherein the recurrent neural network comprises a long-short term memory (LSTM) block.

19. A method for identifying mismatched aircraft configurations comprising obtaining input data from a pilot input device;
processing the input data into text;
obtaining a trained artificial intelligence (AI) and/or machine learning (ML) checklist model;
analyzing the text via the trained AI and/or ML checklist model, wherein analyzing the text via the trained AI and/or ML checklist model comprises:
determining if the text describes a checklist item; and
if the text describes the checklist item, determining if the text further describes an intended aircraft configuration value based on the checklist item;
comparing the intended aircraft configuration value to a current aircraft configuration value; and
if a mismatch between the intended aircraft configuration value and the current aircraft configuration value is detected, sending an alert message to an output device.

20. The method of claim 19, further comprising:
analyzing a duplicate text, or another text based on duplicate input data, via the trained AI and/or ML checklist model;
determining a duplicate intended aircraft configuration value based on the duplicate text or the another text based on the duplicate input data;
comparing the intended aircraft configuration value to the duplicate intended aircraft configuration value; and
if a mismatch between the intended aircraft configuration value and the duplicate intended aircraft value is detected, declining to send the alert message.
